(19) United States
(12) Patent Application Publication
(10) Pub. No.: US 2003/0187725 A1
(43) Pub. Date: Oct. 2, 2003

(54) Monitoring professional development

(76) Inventor: Joseph Brent Jotkowitz, Woodland Hills, CA (US)

Correspondence Address: Colin P. Abrahams, Suite 400, 5850 Canoga Avenue, Woodland Hills, CA, 91367, US

(21) Appl. No.: 10/113,359

(22) Filed: Mar. 29, 2002

(51) Int. Cl. G06F 17/60

(52) U.S. Cl. 705/11

(57) ABSTRACT

A computer networked system for monitoring professional development includes a main data base containing data relating to a plurality of participants whose professional development is being monitored. The data comprises requests for information and responses thereto in at least one competency of professional development. A processor is associated with the main data base for working and sorting the data relating to a participant or a group of participants to produce feedback based on the data in a wide variety of formats. An input device is provided and capable of establishing communication with the main data base for inputting requests for information forming a portion of the data. A review device is also provided and capable of establishing communication with the main data base for receiving from the main data base the feedback.

### FIELD AND BACKGROUND OF THE INVENTION

This invention relates to methods and techniques for assessing and analyzing professional development, and providing feedback thereon including coaching, assistance and the like.

In the corporate and business world, the monitoring of professional development by employees, employers, managers and other workers has become an integral part of business life. In many companies, and particularly larger corporations, employees are constantly or periodically monitored to assess performance, and to obtain data and information relating to that persons's activities within the company. Such information is used for many purposes. For example, the data generated by assessing a persons's professional performance may be used in determining future activities of the company, assessing the individual's salary and remuneration based on the performance, and even determining whether that person should continue employment at that particular company.

Over the years, the assessment and analysis of development of professional development has become increasingly complex, and many different factors and key areas are included in assessing a worker's performance.

In many instances, however, the information tends to become static or unused, or at least not optimally used, because of the difficulty in making it available to sources that would require such information. One obvious such source which would benefit from a continuing and dynamic assessment of performance would be the employee herself, who could receive constant input as to performance, so that adjustments and changes in emphasis can be made in response to feedback. Others include, but are not limited to, managers, directors, vice presidents.

### SUMMARY OF THE INVENTION

According to one aspect of the invention, there is provided a computer networked system for monitoring professional development, the system comprising: (a) a main data base containing data relating to a plurality of participants whose professional development is being monitored, the data comprising requests for information and responses thereto in at least one competency of professional development; (b) processing means associated with the main data base for working and sorting the data relating to a participant or a group of participants to produce feedback based on the data in a wide variety of formats; (c) an input device capable of establishing communication with the main data base for inputting requests for information forming a portion of the data; and (d) a review device capable of establishing communication with the main data base for receiving from the main data base the feedback.

Preferably, the requests for information relating to a participant are sent by email to at least one respondent at a respondent computer capable of establishing communication directly or indirectly with the main data base, and the responses thereto are directed back to the main data base and matched with the requests for information relating to the participant.

The input device and the review device may be the same, for example, computers, and may establish communication with the main data base via the Internet. Preferably, security identification processes are effected between the input and review computers respectively and the main data base before any transmission of data or feedback to or from the main data base occurs. Further, electronic payment may be effected before any transmission of data or feedback to or from the main data base occurs.

The requests for information, and any changes thereto, relating to a participant may be created at the input or review computer and transmitted to the main data base to form part of the data in respect of said participant.

Preferably, the main data base comprises a list of resource items relating to professional development which are available for transmission to the review computer. One or more of the resource items may be matched by the processing means with the feedback relating to a participant, the resource items being matched according to the nature and content of the feedback and thereafter forming a portion of the feedback. Responses are preferably processed by the processing means substantially immediately so that new responses are integrated with existing data relating to a participant and made available for the review computer for review on a real time basis.

According to another aspect of the invention, there is provided a method for monitoring professional development using a computer network, the method comprising: (a) creating a main data base containing data relating to a plurality of participants whose professional development is being monitored, the data comprising requests for information and responses thereto in at least one competency of professional development; (b) sending electronically the requests for information to at least one preselected respondent and receiving a reply thereto into the main data base; (c) associating processing means with the main data base for working and sorting the data relating to a participant or a group of participants to produce feedback based on the data in a variety of formats; (d) connecting an input device capable of establishing communication with the main data base for inputting requests for information forming a portion of the data; and (e) providing a review device capable of establishing communication with the main data base for receiving from the main data base the feedback.

According to the invention, there is provided a method for assessing and analyzing professional development in a dynamic and ongoing manner, providing the ability of a number of diverse sources to provide input, so that the assessment of performance is more broad-based, current and accurate. In a particular aspect, the method for assessing and analyzing professional development is carried out online, using electronic mail or secured electronic transfers of information to collect information.

Once collected, the information is preferably subjected to statistical analysis and assessment so that the data is presented back to a party of interest, such as a manager or the employee, to provide real time feedback on performance in a number of strategic areas.

Definitions: In the specification, the word “participant” refers to the individual, group or organization whose performance or professional development is being evaluated and analyzed. The term “respondent” refers to those individuals who are providing input or feedback to specific questions relating to the participant. The term “organization” refers to the corporation or entity at which a participant and/or respondents may be employed or associated with. The term “registrant” refers to the entity, which would typically be the organization, which is conducting the professional development assessment and analysis in terms of the invention. The term “professional development” is meant as a general description to refer to any aspect of job performance or ability and issues relating thereto; no limitation of the job nature is intended, and such jobs may include conventional employment, independent contractor work, individual practice, whether paid by salary, remunerated by commission, or performed without pay. The term “competency” in this specification is intended to denote any particular skill, behavior, attribute, characteristic, personality trait and the like, of the participant, group, organization etc., which can be assessed and analyzed in accordance with the present invention.

In a preferred form, the assessment and analysis method of the invention is an online professional development tool, which may potentially be used by a particular employee from the beginning to the end of his career. The method follows professional development of the person, and preferably involves at least some of the following steps and components:

(a) assessment, by asking a respondent to answer specific questions relating to a participant in a number of diverse areas which may be tailored to the particular job of the participant;

(b) compilation of the data, by analyzing these questions and organizing the replies into a cohesive and understandable format;

(c) presentation of the feedback, which may vary or may be selected based on who is requesting the information;

(d) highlighting areas of success/failure and those in need of development, by separating out different factors and presenting them in a logical format;

(e) providing information, resources or advice relating to improvement of performance, including direct online advice, or reference to other sources, seminars or teaching aids which may be relevant to a particular participant;

(f) capability to repeat the process over time, including review over a specified period of time, and to measure changes or improvements which may lead towards success or failure;

(g) provide management tools to manage the assessment process by emphasizing or selecting competencies for which input or feedback is required, such competencies considered vital or more important to the participant, as well as the ability to evaluate the extent and quality of use of the system and to assess an organization's or group's effectiveness and performance.

Assessment

This aspect of the invention is for the assessment of predetermined developmental areas, as well as areas considered as important issues by, for example, a client of the corporation at which the participant is employed. The assessment is very flexible in that it can measure a unique number of measured attributes, and can be tailored according to the nature of the industry, the type of work performed, and its relevance to a team within the organization. Typically, the assessment aspect of the invention will constitute a series of questions, which can be predetermined, and which are developed in connection with clients of the participant or his corporation, or within the organization itself. This allows for a more accurate assessment of key issues, and attempts to synchronize the development of the participant with the core values and objectives of the organization itself.

Compilation of the Data

The answering of the various questions under the “assessment” aspect of the invention results in the production of usable data, and this data is complied and coordinated using many unique characteristics and methods. Preferably, it is completely automated-and performed online, preferably using computer servers which are local to each registrant.

The data is computed using high and low scores, mean averages, summary charts, comparative charts, demographic comparisons and various statistical analyses such as F-test, T-test and correlations. This information, duly compiled, is preferably stored on a main server, and is continually updated and adjusted based on incoming feedback, so as to provide accurate information in real time.

Presentation of Feedback

The data, once compiled, is presented as feedback, which may take a variety of forms. In one embodiment, this feedback may be presented to a client or registrant individually as a portfolio sheet where each participant, manager etc. is able to determine his or her “value” for each developmental area. Such information is shown and illustrated using mean scoring, accentuating the high and low scores, showing increases and decreases in scores based on previous input, providing trends in the feedback, and displaying charts that analyze the data on numerous levels or categories. These levels or categories may include the participant herself, as well as senior management, peers, clients and subordinates. The information may be broken down demographically, using such issues as age, age-groups, gender, ethnicity, socio-economics, and schooling level. Other forms of presentation may be feedback with respect to job satisfaction, years of service, increases or decreases in job satisfaction, training history, longevity, amount of communication, organization level, and job title.

The information may also be broken down by organizational distinctions, and these may include industrial categories, departments, regions, territories, groups and teams working on various projects.

All of these factors may be shown to a participant or registrant using a variety of graphics for easy visual digestion of the information, including bar, pie, ranking and percentile charts. Specific comments which are presented by respondents may also be included, without censorship, as each respondent may give specific examples based on observation of other factors.

One advantage of the present invention is its uniqueness in tracking a wide range of measurements and comments for any question within one or more competencies in real time. In other words, when a participant reviews the professional developmental feedback of information, such as by logging on to a computer website, as will be described below, any adjustments or changes that have taken place since the previous review of the information will be updated instantly. Thus, participants and others using the system are able to get as many “snapshots” of performance and feedback as desired or considered necessary.

Areas of Success and Need for Development

A preferred form of the invention enables the method for assessing the professional development to take the feedback from respondents and provide a clear “snapshot” of each participant's strengths and weaknesses. As the feedback is collected, computed and presented, illustration of a participant's strengths and weaknesses are both products of the analysis. Thus, each participant will be able to see where his or her strengths lie, where high scores are obtained, and make comparative analyses, as appropriate. Further, each participant will be able to view areas considered as requiring improvement, where low scores, and comparative analysis, indicate a perceived deficiency. The invention is therefore highly advantageous and unique in that it identifies specific areas requiring future training and development, shows comparable scores to provide context to a score, and such information is provided on an ongoing and current basis.

Resources to Improve Performance

In one aspect, the present invention goes well beyond merely presenting feedback and scoring competencies. The invention may provide a list of a variety of resources which focus on both general areas for improvement, as well as specifically identified developmental areas which require further attention. Such resources may include, but are not limited to, models, tips, techniques, online coaching, “real-time” feedback, videos, online courses, mini-courses, presentations, reading recommendations for articles and books, white papers, research, live online coaching, chatrooms, and other forms of instruction. The invention is dynamic in the sense that it is continually updated on a regular basis, so as to include the latest research within its database of research and make the most appropriate and optimal recommendations to correct identified weaknesses in a particular participant's performance.

Capability to Repeat Process, Measure Success/Failure

The assessment and analysis method of the invention is also unique in that it is able to measure success, improvements, and failure, as the performance analysis proceeds. This is preferably achieved by using bench-marking techniques, and in assisting participants with the setting up of developmental goals. Thereafter, the invention preferably provides strategies to help participants attain these benchmarks and goals and measure the process along the way. The invention is also capable of before-and-after testing around predetermined time frames. The scores so produced in the feedback will be unique because they measure the “value” a person demonstrates in a particular period, and show whether that value has increased, decreased, or stayed the same. This function has infinite possibilities, and is unique in that it will be able to measure changes on an ongoing basis.

Management Tools to Manage the Process

Another aspect of the invention lies in its ability to permit “behind the scenes” management, which allows each participant to manage his or her own professional development. These capabilities include: selecting the competencies to be measured, creating questions that attempt to accurately assess those competencies, designing the assessment to measure desired performance areas, initiating the assessment process, managing the number of assessments being submitted, adding or removing people constituting respondents, as well as varying the questions and competencies along the way. Further, the capabilities permit reinitiating the process to measure changes in perceived performances, as demonstrated by averages, scores and charts.

Another aspect of the invention is its ability for use as a human resources management tool, which provides a large picture view of all of the participants involved to a manager. This is a clear advantage of the invention, since it provides current reports for individuals, teams, groups, departments, territories and organization and industrial input. Further, it allows personnel at organizations to view the utilization, practicality, validity and the reliability of a particular product within that organization.

In a preferred form of the invention, a participant or organization is registered with an internet online provider having the software and capability to carry out the assessment and analysis of professional development. Once signed on, the individual would enter preliminary data, including name, passwords and other identifying information, and thereafter choose or design an assessment program. Competencies and questions, as considered relevant, would be selected, and thereafter reviewed.

Thereafter, an appropriate list or group of respondents is selected as providers of feedback, and each such respondent is e-mailed an internet link that takes respondent to the relevant assessment questions and the like for feedback. The results, from those respondents replying, are then analyzed online, and can be viewed by the participant and managers or other relevant organization personnel.

### BRIEF DESCRIPTION OF THE DRAWINGS

FIG. 1 is a flow-chart showing the process of the invention for assessing and analyzing professional development of a participant or group;

FIG. 2 shows a typical “log-in” page whereby a participant or other authorized personnel can connect to the system to provide input, obtain feedback, direct competencies, and the like;

FIG. 3 is a table showing “Professional Development Portfolio” providing, in one form, a feedback summary based on the replies of respondents;

FIG. 4 is a feedback table providing more detailed information relating to the “credibility” competency;

FIG. 5 is an example of a list showing respondents whose input has been solicited;

FIG. 6 is a table showing a participant's rankings in various contexts and categories;

FIG. 7 is a table showing averages with respect to credibility measurements, broken down into certain categories;

FIG. 8 is a bar graphic representation showing “total credibility averages” in response to specific questions;

FIG. 9 is a bar graphic representation showing “total self-averages” in response to specific questions;

FIG. 10 is a bar graphic representation showing “total senior averages” relating to questions on credibility provided by respondents in response to specific questions;

FIG. 11 is a bar graphic representation showing “total peer averages” in measuring credibility based on questions to respondents;

FIG. 12 is a bar graphic representation showing “total direct report averages” based on replies of respondents to specific questions;

FIG. 13 is a bar graphic representation showing “total client report averages” based on replies of respondents to specific questions;

FIG. 14 is a table showing “comparison averages” and various comparison charts which are available for viewing by the participant or other authorized personnel on a variety of different issues; and

FIG. 15 shows a list of resources available to the participant or other personnel, including hyperlinks, for further review by a participant.

### DETAILED DESCRIPTION OF THE INVENTION

The present invention relates to a method for assessing and analyzing professional development. In a preferred form, the method is carried out at a computer having an online connection to the Internet. Participants, respondents and other persons involved in the assessment and analysis are able to log-in to a predetermined website using their computers, in order to initiate the various interactions. Normally, participants and respondents will communicate through sending of e-mails over the internet, but it is also an aspect of the invention that the various communications be effected through dedicated or secured lines for communication.

Once a participant or respondent has appropriately registered at the server computer, various communications follow, providing feedback or input, or a review of such information, according to the user's preference. The information is duly stored in the server computer and analyzed, and feedback provided in a number of different areas and formats, as will be described below.

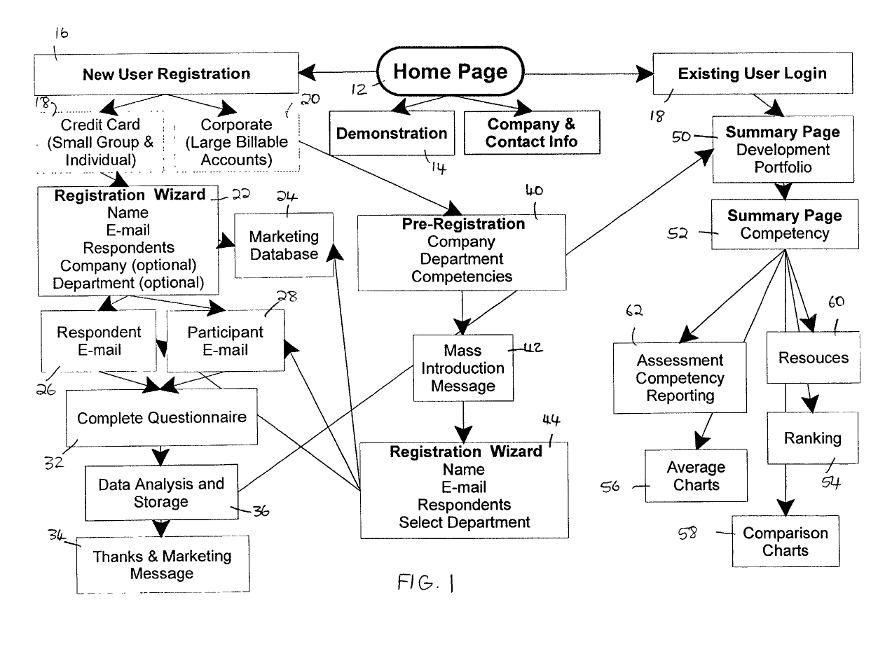

An overall representation of the various steps of the invention can be seen in FIG. 1 of the drawings.

With reference to FIG. 1, a participant logs in, by connecting with a home page 12 on a server computer, which carries out the various steps and procedures of the invention. Once connected to the home page 12, the user will typically face three options. The first option is for a demonstration 14, in which the user will be provided with an overview and demonstration of the method of the invention. Various different levels of demonstration may be provided, and demonstrations may be categorized according to the nature of different industries or businesses, so that potential users seeking information will receive a more relevant demonstration in terms of their potential need.

On the home page 12, the user will be faced with two other choices. The first is a new-user registration option 16, and the second is an existing user option 18. As each name implies, a new user option 16 is intended for those users who wish to commence a professional development assessment and analysis, either as an individual, or on behalf of a corporation. The existing user 18 option would be for users who are already registered with the system, and wish to input further information, or obtain feedback, as will be described below.

An overview of the new user procedure will now be provided, with reference to FIG. 1 of the drawings. The new user 16 will typically be a small group or individual 18, or a large corporate entity 20. For the small group or individual 18, the user will be requested to input information regarding an appropriate credit card, so that payment for the service in assessing and analyzing the professional development can be charged to that credit card account. The credit card information will be processed in a conventional way to determine validity, and acquire the necessary authorization. Other forms of payment are, of course, possible.

Once the credit card information and authorizations have been completed, the new user, consisting of the small group and/or individual, moves onto the next step, which shows a “registration wizard” 22. At this juncture, the user will be requested to input information, including the user's or participant's name, e-mail addresses, a list of potential respondents with full name and e-mail addresses, as well as certain optional information, including the name of the particular company and, where appropriate, the department within that company.

As an optional or side issue before the method of the invention is implemented and carried out, the user may be put into to a marketing database 24, which is designed to provide information to the host for additional contact and information.

Completing the registration requirements, as indicated in box 22, the user then identifies himself as a participant, namely, a person whose professional development is being evaluated. The respondents are indicated in box 36, while participants are indicated in box 28, each following the registration procedure.

The participant 28 is then directed to the assessment page 30, where the participant is able to provide a self-analysis feedback. This is where information is generally stored relating to that participant's performance, as determined by the various respondents.

The respondent 26, who has received an e-mail request, provides feedback with respect to requested information, as indicated in assessment box 32, and this information is e-mailed back to the relevant feedback areas relating to the participant for assessment and analysis, as will be described below. Respondents are thereafter moved to the final screen 34, which may provide certain information and messages, and thanks the respondent for the input.

The participant, after providing any self input, as indicated in box 30, is then able to access a data analysis and storage screen 36, which also allows the participant to review feedback relating to professional development.

The above description indicates generally the sequence of events for small group or individual users, as indicated in box 18. Variations in this procedure are possible within the scope of the invention.

For large entities or large corporate users 20, a pre-registration box is provided wherein personnel input details relating to the company, the various departments which will require assessment and analysis, as well as the various competencies which will be tested. For new corporate users which potentially constitute large billable accounts, the pre-registration will also have to be accompanied by necessary arrangements provided by the server for payment, including checks for credit worthiness, retainers and other financial issues. Once pre-registration has been completed, the user is moved to a box containing a mass message 42, which may be tailored to address all users in that company, and contain information or directions relevant to the assessment of the various participants. The next step is to take the user to the registration wizard 44, in which the user inputs his or her name, e-mail address, a list of desired or required respondents, and an indication as to which departments such user is in, so that the feedback and further information can be appropriately placed and analyzed.

Once the appropriate entries have been made, the user can be taken in a number of different directions. First, the user may be referred or choose to enter the marketing database 24, which has already been discussed above with respect to the small group or individual users. Other alternatives relate to the nature of the user, with participants being capable of viewing participant e-mail 28, or respondent e-mail 26, already discussed above. From the participant e-mail 28 and respondent e-mail 26, the relevant user may be referred to the assessment boxes 30 and 32, and follow the same procedures already described.

A further option permits the user to move directly to the assessment screen 30, if a participant, and thereafter to the analysis and storage area 36, so that a review of feedback from respondents can be studied.

The home page 12 also includes a link for users who have previously used the system. Such users will proceed directly to the existing user log-in 18. Such users may comprise managers of corporations, as well as the participants within that corporation. Upon entering the appropriate identifying information in the existing user log-in section 18, the user is then taken to a development portfolio summary page 50. This development portfolio summary page provides the user, namely the manager or participant, with an overview of the entire professional development portfolio of a participant, and a summary of the feedback which has been received. A more detailed overview of the development portfolio summary page 50 will be discussed below.

From the development portfolio summary page 50, the user can select any one of the numerous competencies overviewed in the development portfolio summary page 50, and, when selected, proceed to the competency summary page 52. This competency summary page 52 provides considerably more detail as to the various components of a particular competency, how it is made up, and the various categories which have contributed towards this competency, as well as the specific feedback from a category. A more detailed review of the competency summary page 52 is provided below.

Once the user has had an opportunity to review the development portfolio summary page 50 and one or more competency summary pages 52, he or she may be referred to a number of different areas, depending upon the input or further information which is required. Some of these are discussed below.

One option for the user is to review the ranking box 54, in which the participant, or that person's manager, can review his ranking in a number of different categories. Thus, a participant may be able to determine his or her standing within a particular work team, in a department of the corporation, in the organization as an entirety itself, or, broadly, in the industry, to the extent that this information is available. This will be further discussed below.

The user may also be referred to a page for average charts 56. As will be discussed below in more detail, a significant number of average charts covering a wide variety of options can be presented to the user. For example, the average may be presented with respect to overall scores, or changes. Additional average charts may be presented with respect to a particular competency, such as total credibility averages, or total self averages in a particular competency. Total senior averages, total peer averages, total direct report averages and total client averages may also be available, and the entirety of this input would be very useful to a user in assessing his or her performance when compared with others in similar or related positions.

The user may also have access to resources 60, as will be described briefly below. The resources may be selected by the system according to the nature of the competency ratings and scores by the participant, and the issues which may need attention or further input by way of such resources.

Another option available to the user is the assessment competency reporting 62. This enables the user to view through a hyperlink details relating to competencies, skills, etc.

Reference is now made to other Figures in this application, which provide further details relating to the various methods and procedures overviewed in the flow-chart illustrated in FIG. 1 of the drawings.

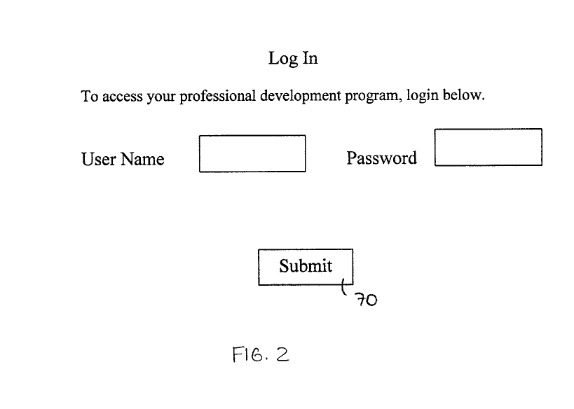

With reference to FIG. 2, there is shown a straight-forward log-in page on the internet, wherein the respondent, participant or other user of the system types in his or her user name, followed by a previously selected password. The use of a password ensures the necessary security of the system, so that unauthorized persons do not have access to highly confidential information which may be stored within a particular participant's professional development portfolio. With the necessary user name and password entered, the user clicks on the “Submit” button 70, and then gain access into the system, and presented with various options, as discussed with respect to FIG. 1. These essentially comprise a log-in for existing users, a demonstration for interested persons, and a new-user registration. Such a web page may also include contact information whereby the user is able to obtain information to contact the overall system managers for possible sign-up and registration.

It will be appreciated that the various log-in, registration and identification steps described above are fairly routine for users of the internet, and variations are of course possible within the scope of the invention.

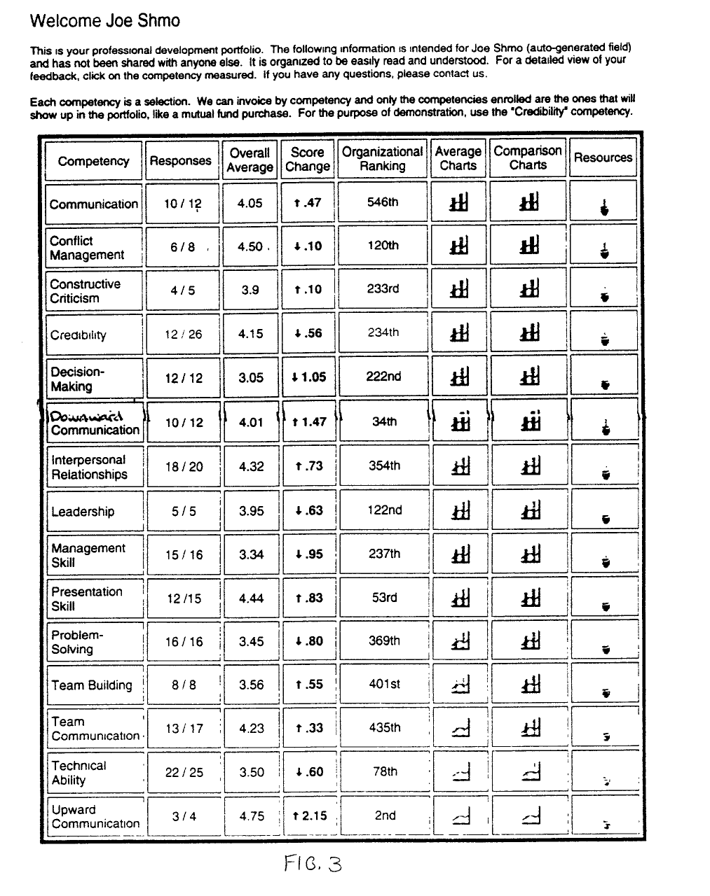

In FIG. 1, the sign-on of the user to the development portfolio summary page 50 was described. Reference is now made to FIG. 3 of the drawings which shows a table representing such a development portfolio summary page. In FIG. 3, the left-hand column refers to a number of competencies. As will be appreciated, the term “competency” in this specification is intended to denote any particular skill, attribute, characteristic, personality trait and the like, of the participant, which can be assessed and analyzed in accordance with the present invention. As an example, some competencies are listed in FIG. 3 of the drawings, and these include: conflict management, communication, credibility, interpersonal relationships, leadership, presentation skills, problem solving, and technical ability. Other competencies are mentioned in FIG. 3, and the above list is not intended to be exhaustive. Additionally, competencies may be specific to particular industries, and therefore a particular participant may find certain competencies much more important for the assessment of professional development than others. For example, a design engineer may be interested in competencies such as technical ability and problem solving, while issues of conflict management and management skill may be of less importance. The converse may be true for a participant who works in, for example, counseling or personnel issues.

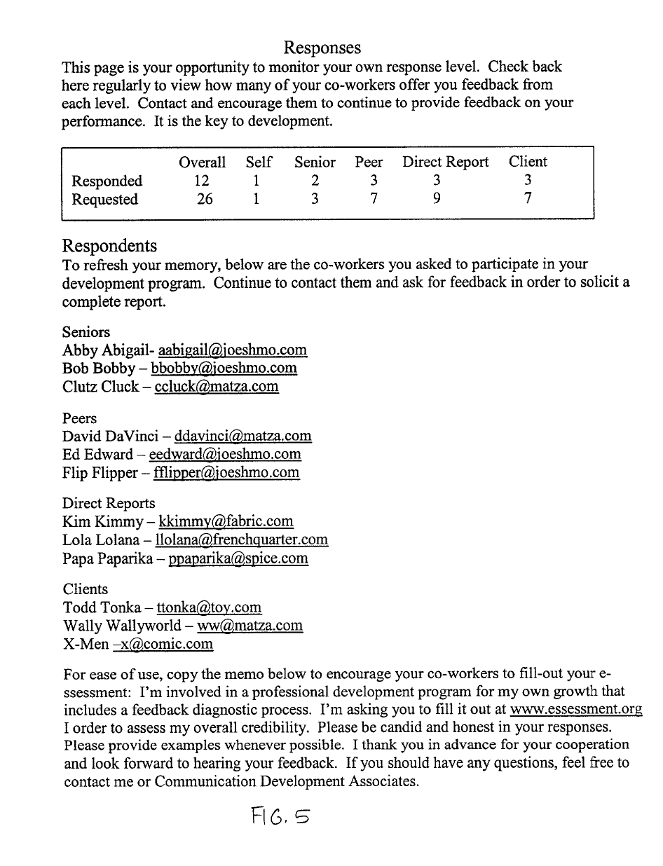

For each competency, the number of respondents whose input and feedback have been solicited is indicated, together with the actual number who have replied. For example, twenty-six respondents may have been e-mailed for feedback on the issue of credibility, twelve of whom have replied. This statistic is indicated under the responses column with the numbers “12/26”. In the normal course, a participant will not be advised as to who specifically has replied, or what the content of the reply was. With reference to these respondents, FIG. 5 of the drawings provides additional information. In the table of FIG. 5, it is shown that twelve respondents have responded in all out of a total of twenty six that have been solicited. A breakdown of the replies received is shown, namely, two out of three senior employees have replied, three out of seven peers, and three out of seven clients. In this table, a list of respondents is provided with respect to each section. Thus, the participant will know that three specific seniors, namely, Abby Abigail, Bob Bobby and Clutz Cluck (all names in this sheet are fictitious) have been solicited, but the participant will not know which two have in fact responded. The specific names of the seniors, peers, direct reports (those persons in the organization reporting to the participant) and clients, are also identified. Participant has the option of resending only to those who have not replied, but whose identities are not known to participant.

It is to be noted that the table of responses and the information contained therein as shown in FIG. 5 can be accessed by clicking, in the professional development portfolio table shown in FIG. 3 of the drawings, on the “12/26” entry under “Responses” with respect to “credibility”. This is a single example, and similar information can be obtained regarding responses under each one of the other competencies which are being tested and assessed. It will be appreciated that the invention does not require the respondents in any one competency to be identical with respondents in another competency. Respondents may be chosen on the basis of who will best represent, and provide the most accurate feedback, regarding that competency.

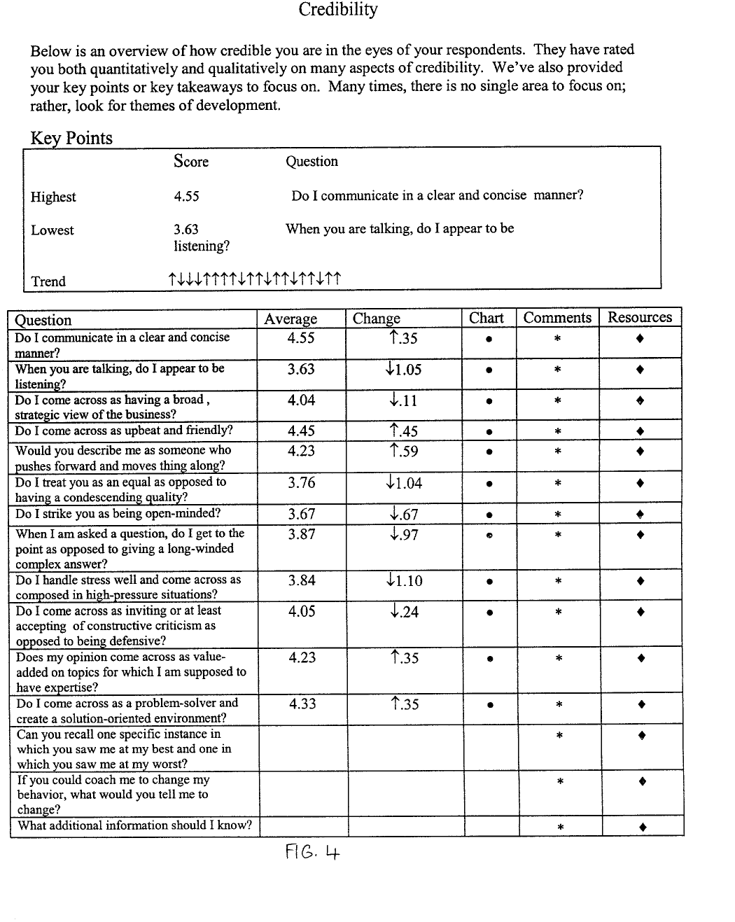

It is possible for a participant to both structure the nature of the questions to a respondent with respect to a particular competency, and/or review those questions when prepared or framed by another. Again, using the credibility competency as an example, it is possible for a participant to obtain more information as to the nature of the questions posed to a respondent, and an analysis of the replies. To do so, the user would click on the word “credibility” in the competency column, which would link to the page with further details, as shown in FIG. 4 of the drawings. Referring to FIG. 4, fifteen specific questions are asked, under the heading “Question”, such as, “Do I communicate in a clear and concise manner?” and the other questions posed below. While certain competencies may include a variety of stock questions, the totality of the questions as a whole may be customized to meet the specific requirements of a particular worker, the nature of the job, organization, as well as the industry. Questions may vary widely in terms of their quantitative and qualitative nature.

With respect to each question, the first of which in the list, as mentioned above, is used as an example, the respondent is requested to rate the participant on a scale of, for example, 1 to 5. With respect to the first question regarding “clear and concise communication”, the participant will note that the average feedback was a score of 4.55, and, in the next column, it can be seen that this score represents an increase of 0.35 from the previous round of feedback. Under the heading “Chart”, an icon is shown, which can be clicked for more information as to the contributors to the average score, and, under the heading “Comments”, there may be specific comments offered which may be useful to the participant in addressing certain deficiencies, or concentrating on certain strengths. Finally, a column for “Resources” is devoted to listing useful sources of information, whether in text, video, or live presentation form, which may be appropriate. Therefore, if, for example, the participant scored poorly on the “clear and concise communication”, the resources column may refer the participant to appropriate literature, seminars or other instruction and training which would be helpful in addressing these this deficiency.

The same procedure is followed, and corresponding information available, for each of the subsequent questions. In this way, the participant is able to obtain extremely useful and detailed and constructive comments relating to a wide range of issues which may be relevant to the effective performance of the job.

A clear advantage of the invention is the “key points”, seen in FIG. 4, showing some highlights of the feedback. This provides the participant with an indication of the area where he or she has scored highest, as well as the area where the lowest scores were obtained. The trend, represented by up-and-down arrows, gives the participant a graphic summary of improvements or deteriorations over time.

Referring back to FIG. 3 of the drawings, one of the headings to provide input to relate to each competency is the “Score Change” with respect to that competency from a previous round of feedback. Once more, using the credibility competency as an example, it will be seen in the fictitious example of FIG. 3 that while the overall average remains a fairly high 4.15, this overall average has in fact declined by an amount of 0.56 from the previous round of feedback. Thus, the professional development portfolio provides a dynamic, usable source of information to the participant who would easily be able to identify areas which are improving and those which are not. For example, a participant may find that an improvement, or decline, may be due to a specific problem. Going back to FIG. 4 of the drawings, a participant would note that there has been a significant downward change with respect to the question “Do I treat you as an equal as opposed to having a condescending quality?”. This decline in the score for this specific question pinpoints for a participant areas which require attention. Conversely, the participant would be able to immediately focus in on areas in which his activity has been well received, and build on these areas, as reflected in the improvement change to the question regarding “decisiveness” and “pushing forward”.

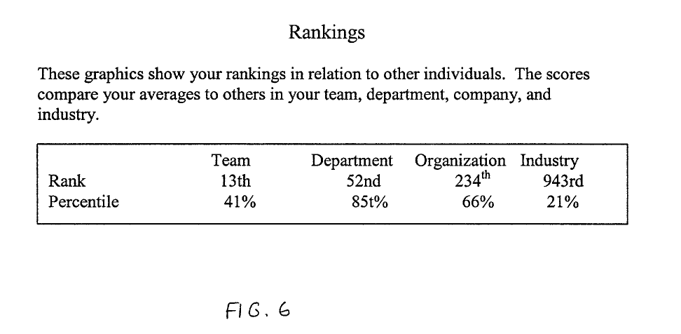

Referring to the professional development portfolio summary page shown in FIG. 3 of the drawings, reference is made to the heading relating to the “Organizational Ranking”. A raw score, again using credibility as the example in this description, shows that the participant ranks 234^{th} in this area. In order to secure more detailed information, the participant, or other authorized user, clicks on the number 234 and is taken to a page showing such further detail, as shown in FIG. 6 of the drawings. In FIG. 6, the participant's rank within certain categorizations is provided. The first category is for the smallest group, namely, the participant's team, in which it can be seen that this participant rates 13^{th}, at the 41^{th} percentile. In the department category, participant rates 52^{nd}, at the 85^{th} percentile, while in the organization category, which is the one indicated in FIG. 3 of the drawings, the participant is 234^{th} and at the 66^{th} percentile. Where industry-wide information may be available, participants ranking within the industry is provided, and in the example shown in FIG. 6, the participant ranks at number 943, in the 21^{st} percentile. This information is useful not only for the participant to understand his or her relative ranking in a number of different contexts, but also provides information regarding the group itself. Thus, the participant may discover that he may be very strong within a team, but much less strong in a department or organization. This would be an indicator that other members of the team are particularly good, or particularly poor, which could help the participant in terms of career decisions, and the organization with succession planning.

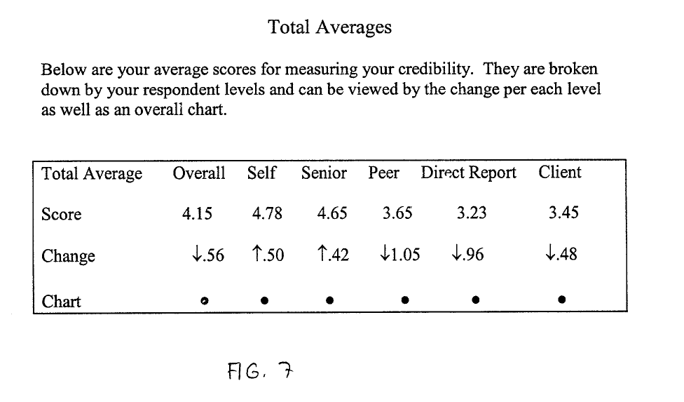

Reverting to FIG. 3 of the drawings, one of the headings with respect to each competency is that of participant's “Average Charts”. By clicking on the icon in the “average chart” column, the participant would have access to important information relating to averages, and the participant's standings therein. With reference to FIG. 7, total averages are shown, once more with respect to the credibility competency. The participant's total average is shown by category, including overall (which is the average already provided in the “Overall Average” heading in FIG. 3 of the drawings), but also for overall average by category, such as self, seniors in organization, peers, employees who report to him, and clients. The participant would note that senior employees score him relatively high, representing an increase from prior feedback (4.65, an increase of 0.42), while those that report to him scored the participant's credibility at a much lower level, which is decreasing (a 3.23 score, down 0.96 from the previous round of feedback). This will alert the participant to a definite difference in the perception of his or her credibility between those senior to him, and those that report to him.

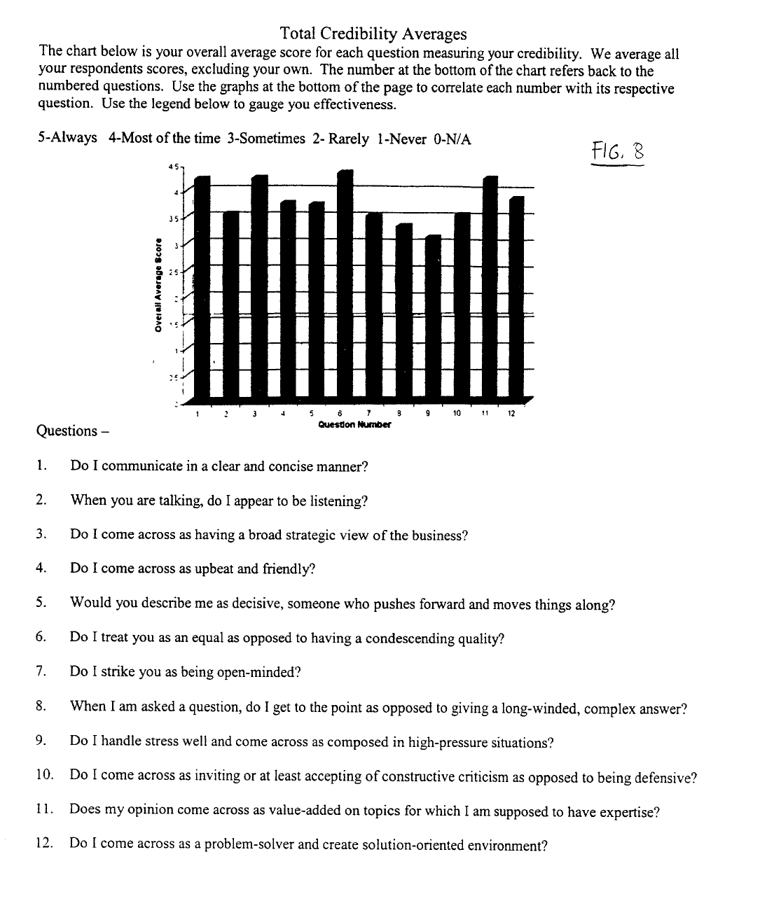

The table for total averages also provides an icon, in the “Chart” heading which can be clicked so that the participant can obtain more detailed information for any one category (such as senior, peer, etc.) and how the respondents in that category see the participant in terms of the specific questions asked under the credibility competency. In FIG. 8, the total credibility averages for each question, discussed above, are provided. Thus, the score for each question is averaged, over all respondents. Thus, in answer to the first question “Do I communicate in a clear and concise manner?”, the bar graph horizontal line number 1, illustrates that the overall average score for respondents answering this question was about 4.15. For question 2, “When you are talking, do I appear to be listening?”, the overall score amongst all respondents is 3.5. The participant can thus review and analyze the particular average score over all respondents, for each of the questions asked.

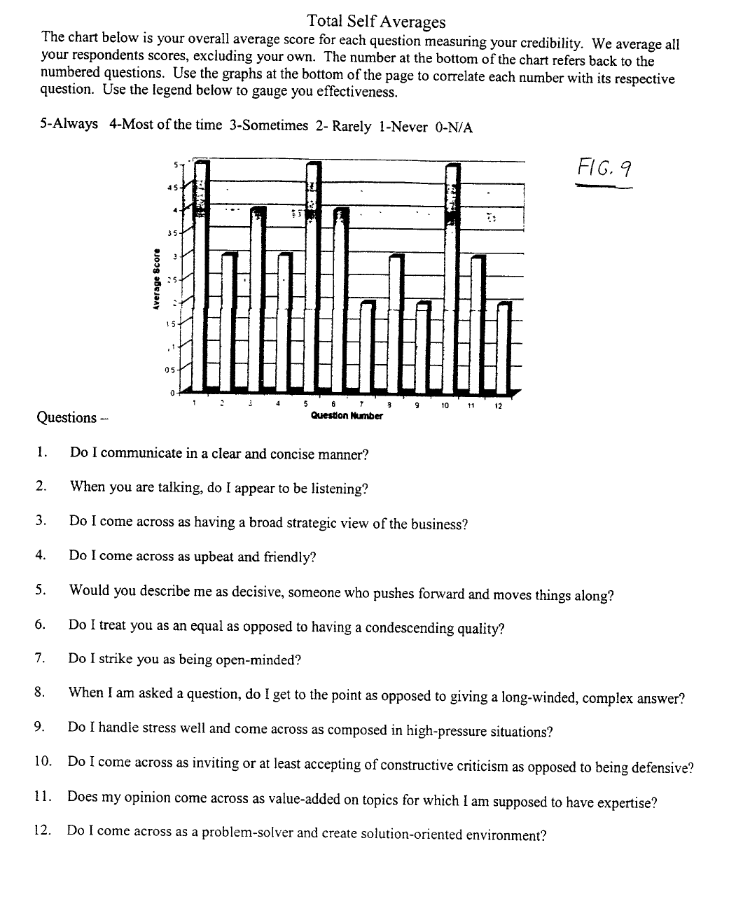

FIG. 9 shows total averages where the participant is assessing himself, and answering the same questions. The same procedure is used where, for example, the participant rates himself almost perfect in response to the question “Do I communicate in a clear and concise manner?”. The average for self analysis can be compared with those in other categories, providing reality check for the participant.

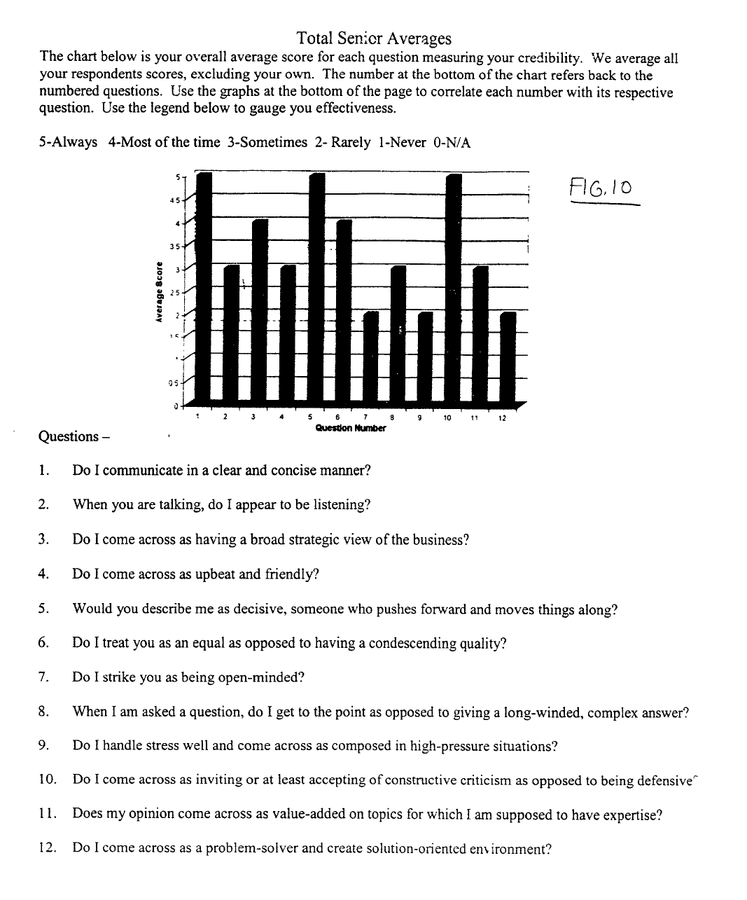

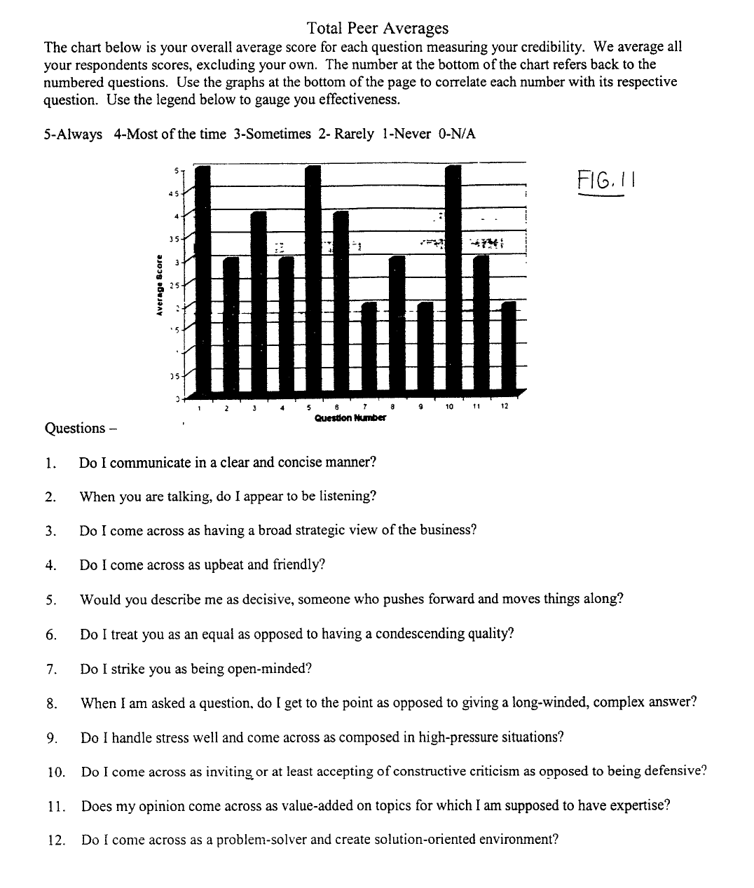

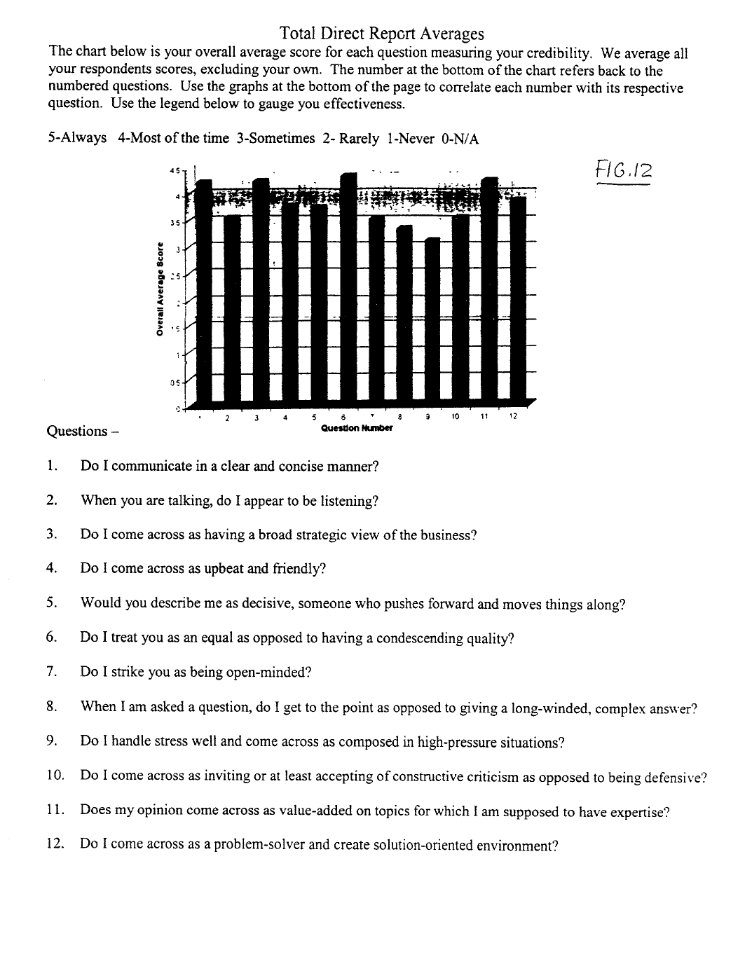

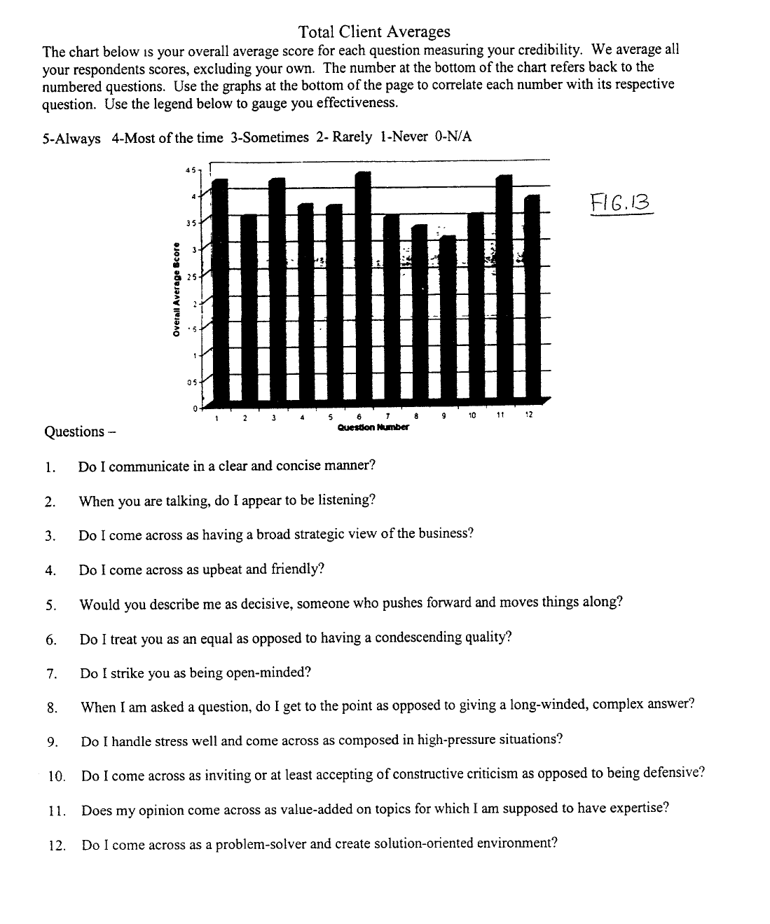

With reference to FIG. 10, total senior averages are provided. In other words, for the questions 1 to 12 listed, a bar graph is provided for the average score of the participants' seniors. In FIG. 11, total peer averages are provided for each of the 12 questions, where the average of those persons constituting the participant's peers are analyzed and presented. In FIG. 12, the total direct report averages can be found, providing an analysis of scores in respect of those respondents who report to the participant. Lastly, FIG. 13 shows total client averages, whereby the participant is able to review answers presented by his or a corporation's clients in respect of these matters.

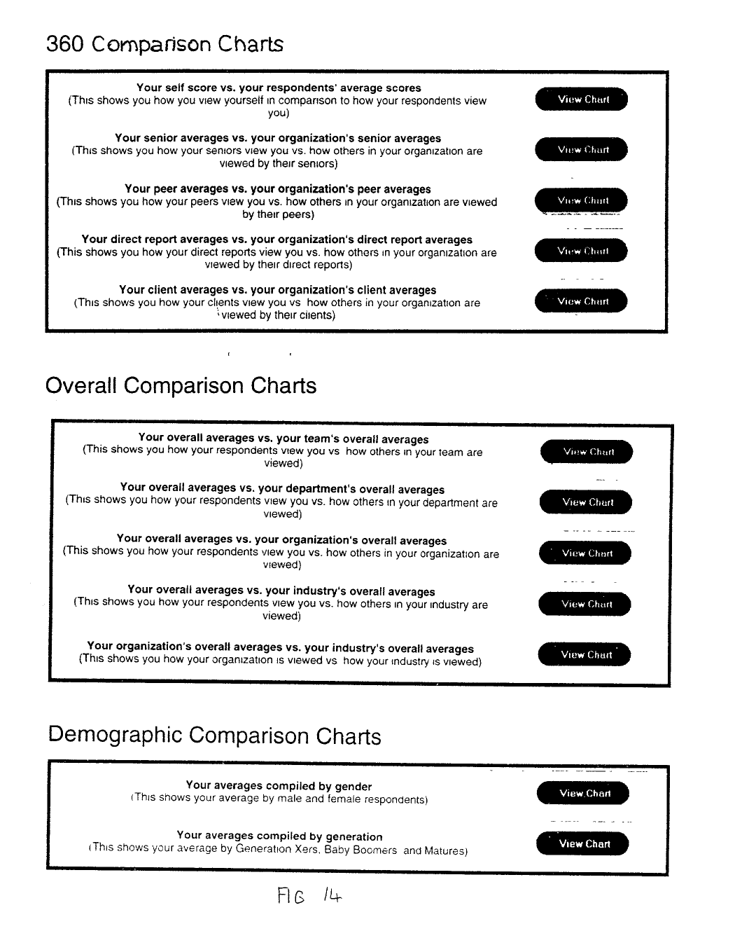

Once more referring to FIG. 3 of the drawings, showing the professional development portfolio summary page, it will be noted that one of the options available to the participant and other authorized users of the system is an opportunity to study “comparison charts”. As will be noted, one of the headings across the top of this summary page is “Comparison Charts”, and such charts are available for each one of the competencies mentioned in the Table. As done previously, comparison charts with respect to the “credibility” competency will be discussed. These are accessed by clicking on the icon under the heading “Comparison Chart”, and in the “credibility” line. When this icon is clicked, the participant or user is provided with a list of different types of comparison charts which are available, as illustrated in FIG. 14 of the drawings. There are a large number of comparison charts which are available, since there is a significant amount of data collected from a wide variety of sources, and presentation of this data can be composed in a wide variety of different ways in order to give a particular participant the best information for optimal use in improving the professional development portfolio.

In FIG. 14, three different categories of comparison charts are shown. The first is Comprehensive (or 360) Comparison Charts, then there are overall comparison charts, and finally demographic comparison charts are provided. With respect to the 360 Comparison Charts, it will be seen that, in the embodiment provided and as shown in FIG. 14, five options are set out. For example, the first option is an opportunity for the participant to view the self score versus respondents average scores. This provides a stark comparison as to how the participant views himself or herself in comparison to respondents. Often, the reality of how others perceive a participant in certain contexts may differ from what the participant believes to be the situation, and this particular comparison chart may help to narrow any gap which may exist in this regard. Various other comparison charts under the 360 Comparison Charts are available for view, as will be seen in FIG. 14. These other comparison charts, with a brief explanation as to the issue and categories being compared, are shown, and the participant can access the comparison chart by clicking on the button “View Chart” associated with each possible comparison chart. Although, in this specification, each specific comparison chart is not shown, these can be presented along the lines shown in previous Figures, such as with bar graphs, pie charts or any other suitable graphic manner which effectively conveys the relevant information.

With respect to the comprehensive Comparison Charts, five of which are shown in FIG. 14, a participant may compare his or her own averages against those of a team, a department, an organization or the industry. This is a useful way not only of comparing a participant's specific performance, but also of obtaining feedback as to the efficiency, efficacy and relative standing of a department, or organization, within an specific industry. A further chart comparing the participant's own organization's averages against that of the industry is also useful for a participant to obtain meaningful feedback relating to the relative ranking or standing of his or her own organization within an industry. An mentioned above, such feedback would be useful in assisting a participant with respect to career choices, and contemplating any career changes.

FIG. 14 also shows demographic comparison charts, which enables a participant to compare his or her own average in certain categories. Thus, these demographic comparison charts may show different feedback and results which have been received from male and female respondents respectively. For example, where the competency being assessed comprises team communication, a participant may find that men are more responsive to such communication than women. This may assist the participant in addressing any weakness which may be unconsciously or subconsciously conveyed in communicating with women. Also in the demographic comparison chart, a participant's averages may be compiled and compared by generation, so that the participant is able to compare his or her performance with others of similar experience or corresponding amounts of time in a particular industry. These are examples only and any demographic may be reviewed.

It should be appreciated that the various comparison averages and charts highlighted in FIG. 14 of the drawings are examples only, and may constitute some of the more important bases for comparison that can be made. However, the various comparisons in FIG. 14 are not intended to be limiting, but merely representative, and any comparison chart may be prepared wherein different factors are presented to provide the most meaningful input and feedback to the participant.

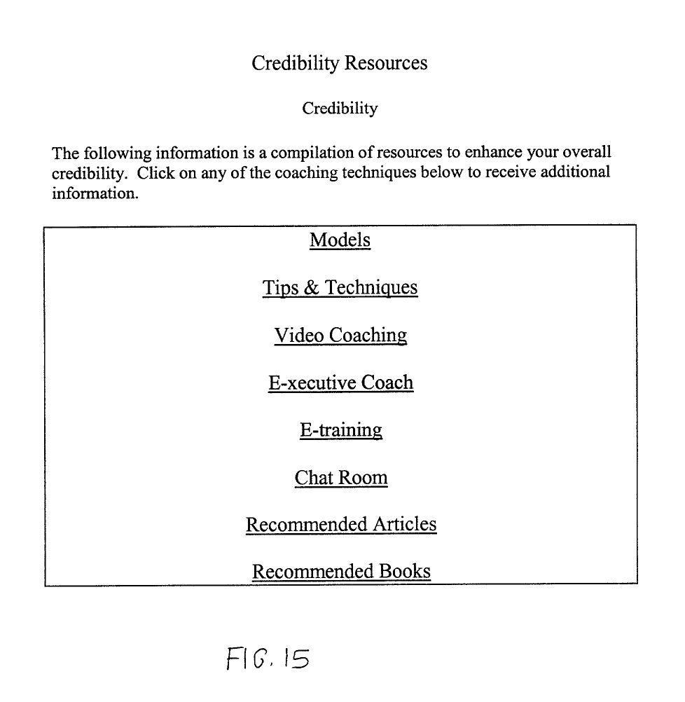

One particularly advantageous aspect of the invention relates to instruction, training, recommendations or referrals to other sources, where a participant is considered to have scored poorly with respect to a specific competency. Referring once more to FIG. 3 of the drawings, the last column is headed “Resources”. In this column, there are a series of icons, one for each of the competencies. Where the icon in the resources column is clicked for the credibility competency, the participant will be taken to credibility resources, as shown in FIG. 15 of the drawings. In FIG. 15, a series of resources, by category, is shown. These resources may differ if overall credibility averages are high, so that the participant can build on these, as compared to resources offered where the overall credibility averages were low, and a different type or response and instruction by the participant is required.

Each of the headings shown in FIG. 15 of the drawings will link the participant to literature, videos, and other types of instructional material relevant to that category. Thus, the “Tips and Techniques” option, when clicked, would open up a list of varying length, showing different types of techniques and tips offered to enhance ones credibility. The credibility resources include such other categories as executive coaching, recommended articles and books, video coaching, seminars and the like, which can be reviewed by the participant in an effort to identify a particular resource or resources which will most assist in addressing a particular problem.

It is an advantageous feature of the invention that the credibility resources, as well as all the other resources offered with respect to other competencies, can continuously be updated and revised based on new literature and approaches which are developing in such competencies, possibly with a focus on specific industries. This particular aspect of the invention makes the professional development assessment and analysis method of the invention an extremely dynamic and active tool. The system does not merely passively identify areas of weakness, but attempts to pinpoint them using the various charts, and provide the participant with meaningful and useful information in an effort to improve a competency, or to salvage one which is shown to be in serious trouble.

In accordance with the invention, the various data provided by participants and respondents is collected online, and a particular assessment may be pre-designed for general application, or customized for a specific participant or client. In collecting data, information is requested from respondents bearing in mind the client's core values and desired traits. The collected data can be sent to various housing sites around the world to provide speed and access. Thus, the information is available in real time, is kept up to date, and allows for substantially immediate and accurate results. Further, a participant who may be poor in a particular area does not have to wait for annual or bi-annual reviews, but can work on a particular deficiency and track its progress incrementally over very short periods of time.

The data is preferably analyzed using a variety of statistical methods. These statistics include the use of mean and median averaging, high and low scores, changes in scores, trends, variants of analyses, T-tests, F-tests, correlation analyses, validity and reliability tests, and the like.

As shown above, with respect to the Figures, the data is collated and presented in a variety of graphic methods. Each participant or user is provided with overviews and summaries, as well as specific details. The presentation of the data includes portfolio, ranking charts, pie charts, percentile charts, bar graphs, comparative charts, pre- and post-test graphs, color distinguishers, increase and decrease in scores, qualitative feedback and warning graphics for high and low impact areas.

Preferably, the master data is housed in a central location where it will have maximum security and reliability. Information is kept in confidence, updated and backed up on a regular basis, and may be kept at numerous sites around the world for safe-keeping.

A significant advantage of the invention is its ability to provide real time and anonymous feedback catered to customized personal areas of professional development. With the correct type of input, a participant can actively seek out training, professional coaching and materials to improve performance. This allows participants to continuously move up through corporate ranks to accomplish success and professional fulfillment.

Respondents are, of course, encouraged to send their replies, and may in fact be participants as well. Respondents feel comfortable providing the information, since it is done anonymously.

The invention is not limited to the precise details which have been described above. As will be appreciated, a wide spectrum of competencies can be tested, and the surveying question in each competency can be tailored and customized to suit particular needs. The essence of the invention is its flexibility and, hence, accuracy, in providing precise feedback to its users.

1. A computer networked system for monitoring professional development, the system comprising:
(a) a main data base containing data relating to a plurality of participants whose professional development is being monitored, the data comprising requests for information and responses thereto in at least one competency of professional development;
(b) processing means associated with the main data base for working and sorting the data relating to a participant or a group of participants to produce feedback based on the data in a wide variety of formats;
(c) an input device capable of establishing communication with the main data base for inputting requests for information forming a portion of the data; and
(d) a review device capable of establishing communication with the main data base for receiving from the main data base the feedback.

2. A system as claimed in claim 1 wherein the requests for information relating to a participant are sent by email to at least one respondent at a respondent computer capable of establishing communication directly or indirectly with the main data base, and the responses thereto are directed back to the main data base and matched with the requests for information relating to the participant.

3. A system as claimed in claim 1 wherein the input device and the review device are the same.

4. A system as claimed in claim 1 wherein input and review devices establish communication with the main data base via the Internet.

5. A system as claimed in claim 1 wherein security identification processes are effected between the input and review devices respectively and the main data base before any transmission of data or feedback to or from the main data base occurs.

6. A system as claimed in claim 1 wherein electronic payment is effected before any transmission of data or feedback to or from the main data base occurs.

7. A system as claimed in claim 1 wherein requests for information relating to a participant are created at the input computer and transmitted to the main data base to form part of the data in respect of said participant.

8. A system as claimed in claim 1 wherein changes to the requests for information relating to a participant are created at the review computer and transmitted to the main data base to form part of the data in respect of said participant.

9. A system as claimed in claim 1 wherein the main data base comprises a list of resource items relating to professional development which are available for transmission to the review computer.

10. A system as claimed in claim 10 wherein one or more of the resource items are matched by the processing means with the feedback relating to a participant, the resource items being matched according to the nature and content of the feedback and thereafter forming a portion of the feedback.

11. A system as claimed in claim 1 wherein the processing means provide a summary page relating to a participant, the summary page setting out preselected competencies and a summary of scores thereof, the summary page further providing hyperlinks in respect of each score to more detailed information relating to that score.

12. A system as claimed in claim 1 wherein the processing means provide at least one comparison chart wherein the feedback of the participant can be compared to other participants, groups, organizations and industry.

13. A system as claimed in claim 1 wherein the processing means provide ranking information wherein the feedback of the participant can be ranked against other participants, groups, organizations and industry.

14. A system as claimed in claim 1 wherein the competencies are selected from one or more of the group consisting of: communication, conflict management, constructive criticism, credibility, decision making, downward communication, leadership, interpersonal relationships, management skills, presentation skills, problem solving, team building, team communication, technical ability, and upward communication.

15. A system as claimed in claim 1 wherein responses are processed by the processing means substantially immediately so that new responses are integrated with existing data relating to a participant and made available for the review computer for review on a real time basis.

16. A system as claimed in claim 1 wherein the processing means works the data to show upward and downward trends based on accumulated data received over a predetermined time period.

17. A system as claimed in claim 1 wherein requests for information are transmitted by email to respondents and replies thereto are monitored to form a portion of the feedback.

18. A system as claimed in claim 17 wherein the respondents are entered in to main data base at the review computer.

19. A system as claimed in claim 1 wherein the processing means is capable of creating feedback based on responses to requests for information, the feedback including one or more of the following: total averages, total competency averages, total self averages, total senior averages, total peer averages, total direct report averages, and total client averages.

20. A system as claimed in claim 1 wherein the input device is an input computer and the review device is a review computer.

21. A system as claimed in claim 1 wherein the input or review devices are selected from one of the following: land based or wireless telephones, computers, personal digital assistants (PDAs), WebTV and pagers.

22. A method for monitoring professional development using a computer network, the method comprising:
(a) creating a main data base containing data relating to a plurality of participants whose professional development is being monitored, the data comprising requests for information and responses thereto in at least one competency of professional development;
(b) sending electronically the requests for information to at least one preselected respondent and receiving a reply thereto into the main data base;
(c) associating processing means with the main data base for working and sorting the data relating to a participant or a group of participants to produce feedback based on the data in a variety of formats;
(d) connecting an input device capable of establishing communication with the main data base for inputting requests for information forming a portion of the data; and
(e) providing a review device capable of establishing communication with the main data base for receiving from the main data base the feedback.

23. A method as claimed in claim 22 wherein the requests for information relating to a participant are sent by email to at least one respondent at a respondent computer capable of establishing communication directly or indirectly with the main data base, and the responses thereto are directed back to the main data base and matched with the requests for information relating to the participant.

24. A method as claimed in claim 22 wherein input and review devices establish communication with the main data base via the Internet.

25. A method as claimed in claim 22 wherein changes to the requests for information relating to a participant are created at the review device and transmitted to the main data base to form part of the data in respect of said participant.

26. A method as claimed in claim 22 further comprising sending a list of resource items relating to professional development to the review device.

27. A method as claimed in claim 22 further comprising the step of providing a summary page relating to a participant, the summary page setting out preselected competencies and a summary of scores thereof, the summary page further providing hyperlinks in respect of each score to more detailed information relating to that score.

28. A method as claimed in claim 22 wherein responses are processed by the processing means substantially immediately so that new responses are integrated with existing data relating to a participant and made available for the review computer for review on a real time basis.
